(19) United States
(12) Patent Application Publication
(10) Pub. No.: US 2006/0102100 A1
(43) Pub. Date: May 18, 2006

(54) Clip-on translator for an animal correction collar

(76) Inventors: Kent Becker, Huntertown, IN (US); William Peter Moore, Fort Wayne, IN (US)

Correspondence Address: TAYLOR & AUST, P.C., 142 SOUTH MAIN STREET, P. O. BOX 560, AVILLA, IN, 46710, US

(21) Appl. No.: 11/254,155

(22) Filed: Oct. 19, 2005

Related U.S. Application Data
(60) Provisional application No. 60/620,469, filed on Oct. 20, 2004.

(51) Int. Cl. A01K 15/02

(52) U.S. Cl. 119/720

(57) ABSTRACT

An animal training system including a translator having at least one receiver and at least one transmitter. The receiver receives a first signal and the transmitter is communicatively coupled to the receiver. The transmitter transmits a second signal dependent on the first signal.

### CROSS REFERENCE TO RELATED APPLICATIONS

This is a non-provisional application based upon U.S. provisional patent application Ser. No. 60/620,469, entitled “CLIP-ON TRANSLATOR FOR AN ANIMAL CORRECTION COLLAR”, filed Oct. 20, 2004.

### BACKGROUND OF THE INVENTION

1. Field of the Invention

The present invention relates to a correction collar system, and, more particularly, to a device to expand the functionality of an animal correction collar.

2. Description of the Related Art

An animal behavior modification system, such as an electrical training system, no-bark collar or containment system typically includes a collar-mounted receiver worn by the animal and a wireless transmitter. The wireless transmitter may include a radio frequency transmitter having a wire loop transmitting a radio frequency signal. The wire loop antenna may define the boundary in which the animal is to be confined. The animal wears the receiving unit attached to its collar. When the animal gets within a predetermined distance of the wire loop antenna, the receiver unit detects the radio frequency signal transmitted from the loop antenna, whereupon a correcting stimulus, such as a good tone/bad tone, electrical stimulation, vibration, citronella spray, etc., is administered to the animal.

The receiver unit, which may apply an electrical stimulation to the animal, typically includes a pair of electrode probes, which extend from the receiver unit, through the collar and contact the skin of the animal. An electrical potential is applied between the electrode probes resulting in electrical current flowing through the skin of the animal to thereby apply an electrical stimulation to the animal.

Animal training systems may also include a handheld transmitter allowing an operator to interact with the animal to ensure compliance with verbal or other instructions. The system may also be self-contained such as a no-bark collar that detects behavior and applies stimulation to the animal

What is needed in the art is a method of expanding the flexibility of an animal correction system.

### SUMMARY OF THE INVENTION

The present invention relates to an animal training system for translating a signal that the correction system would not normally respond to into a signal which the correction system will respond to.

One embodiment of the present invention consists of an animal training system including a translator having at least one receiver that receives a first signal and at least one transmitter coupled to the at least one receiver. The at least one transmitter transmits a second signal to the animal training system. The second signal being based on the first signal.

An advantage of the present invention is that it expands the flexibility of current animal correction collars.

Another advantage of the present invention is that it is easily connected to the collar of a present correction system.

Yet another advantage of the present system is that correction levels associated with the correction system are maintained while the control signals are modified by way of the translator.

Yet another advantage of the present invention is that it receives and processes/translates one type of signal, converts the signal to another type of signal and transmits the process/translated signal to an existing correction collar receiver and/or stimulator.

Still yet another advantage of the present invention is that it is a cost effective way to modify the functionality of a correction collar without any other modification to the collar.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a perspective view of an example of an animal correction collar with an embodiment of a clip-on translator of the present invention clipped thereto;

FIG. 2 is a perspective view including at least part of the next side of the collar of FIG. 1 and showing the attachment of the clip-on translator of FIG. 1 to the collar;

FIG. 3 is a front view of the clip-on translator of FIGS. 1 and 2 being shown as it is coupled together;

FIG. 4 is a perspective view of the clip-on translator of FIGS. 1-3;

FIG. 5 is a top view of the clip-on translator of FIGS. 1-4; and

FIG. 6 is a perspective view of the clip-on translator of FIGS. 1-5.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

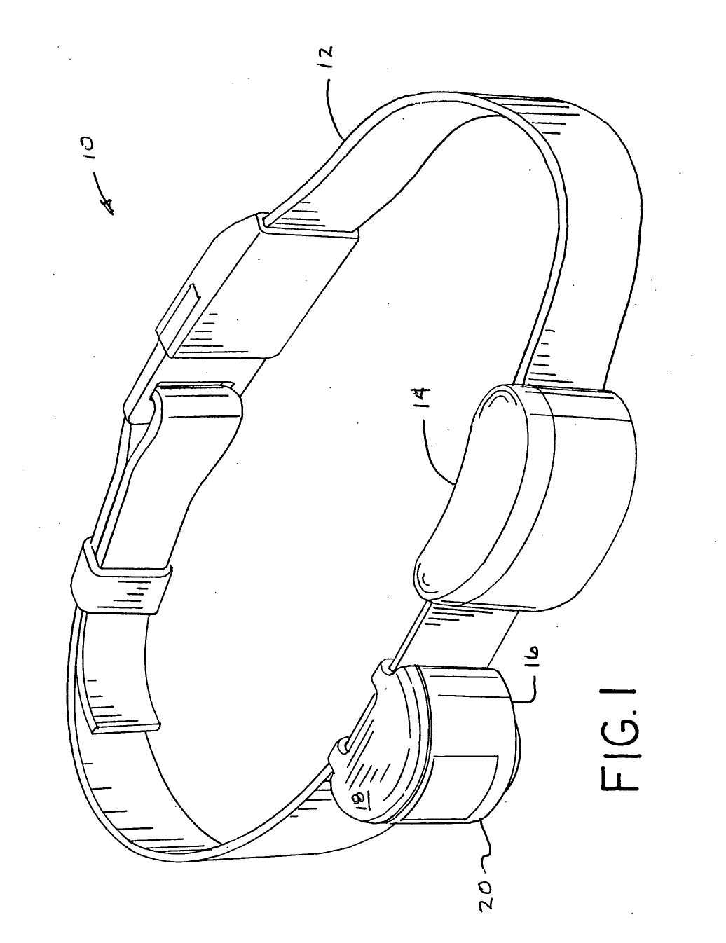

Referring now to the drawings, and more particularly to FIG. 1, there is shown an animal training system 10 including a collar 12, a training device 14 and a translator assembly 16. Collar 12 fits around the neck of an animal and is representative of an apparatus that connects a training system to any portion of an animal. Attached to collar 12 is training device 14, which may include electrodes, not shown, that protrude toward the neck of the animal. Training device 14, also known as a behavior modification device 14, is activated by a signal that is received by a receiver unit therein and provides an appropriate training stimulus to the animal in order to modify the behavior of the animal. Training device 14 may be an Invisible Fence™ containment collar, which responds to a signal transmitted from the buried wire that transmits a signal therefrom.

Translator assembly 16 includes two separate portions which are separable and are defined as first portion 18 and second portion 20. Portions 18 and 20 are separated and are connected to attach translator assembly 16 to collar 12, in a clip-on manner, when portions 18 and 20 are reassembled.

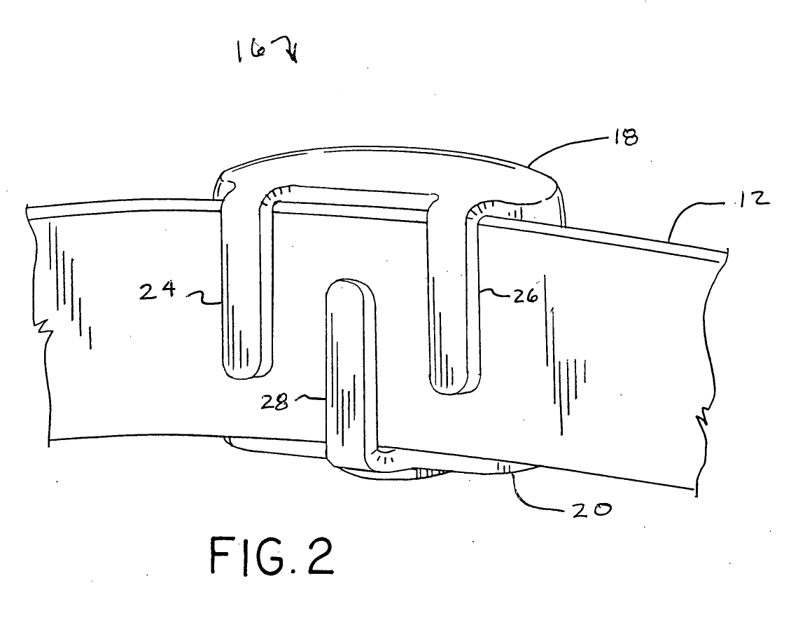

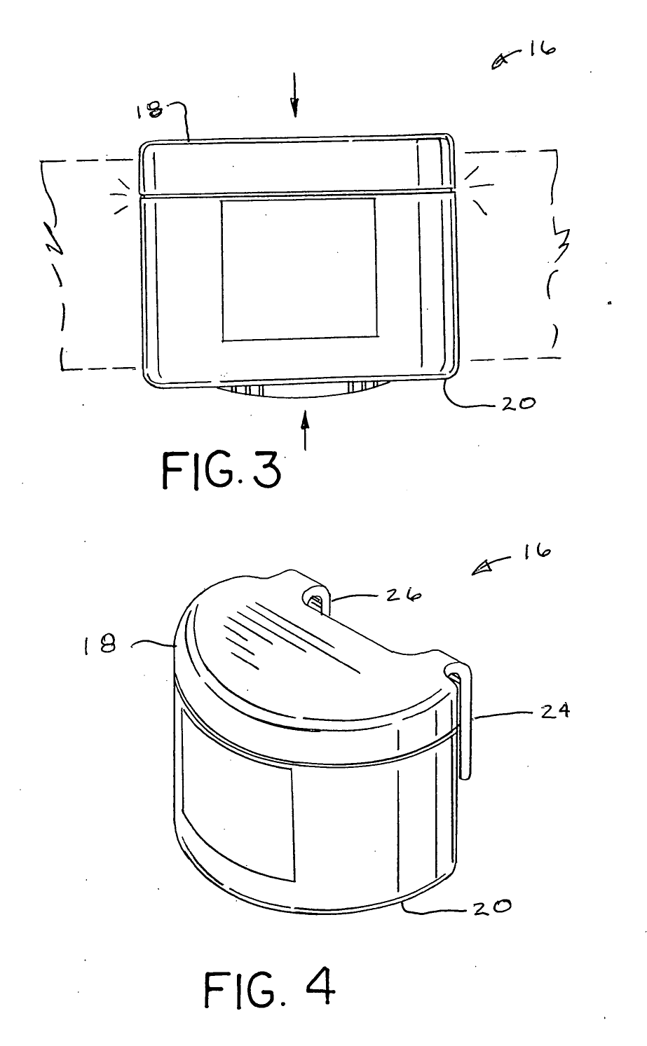

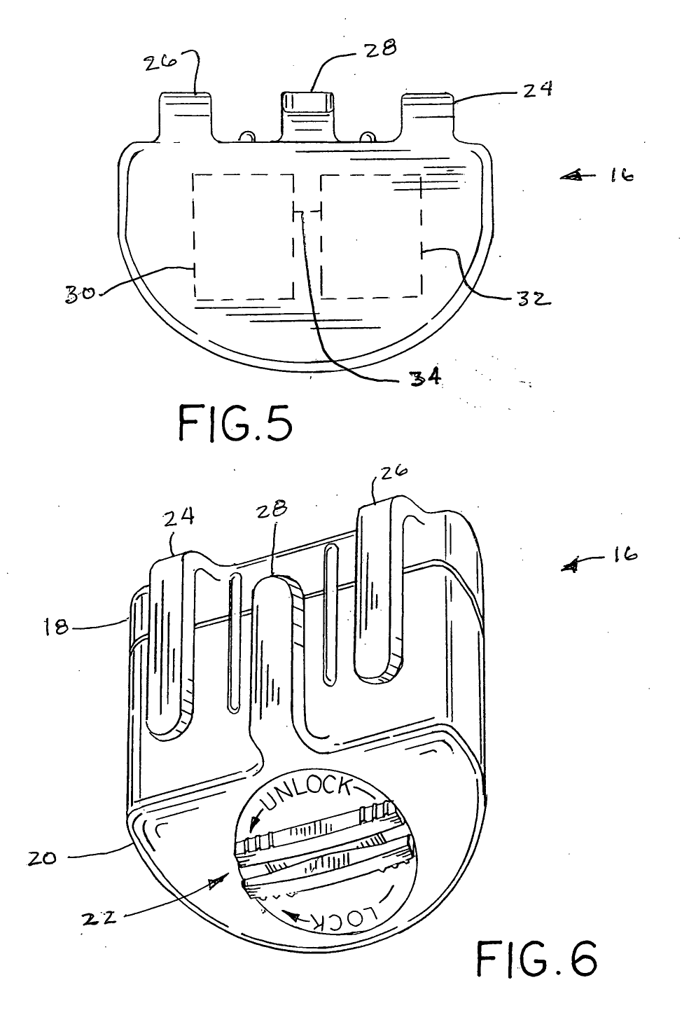

Now, additionally referring to FIGS. 2-6, there is shown a coupling mechanism 22 that is rotated to a locked position to couple first portion 18 with second portion 20, once they are assembled about collar 12. Additionally, coupling mechanism 22 can be moved to an unlocked position in order to separate first portion 18 from second portion 20 to thereby remove translator assembly 16 from collar 12. Prongs 24 and 26 are associated with first portion 18 and prong 28 is associated with second portion 20. Although prongs 24, 26 and 28 are shown having similar forms, shapes different from that shown, as well as shapes which may be otherwise spaced and located, are also contemplated in the present invention. In installing translator assembly 16 to collar 12 prongs 24 and 26 are slipped over an edge of collar 12 and second portion 20 is assembled to first portion 18 while prong 28 also is positioned on the neck side of collar 12.

Contained within translator assembly 16 is a receiver 30, a transmitter 32 and a translator device 34. Receiver 30 receives a signal, which is a signal that training device 14 would not normally respond to and that signal is modified by translator device 34. The information in the signal received by receiver 30 is translated into a second signal, which is subsequently transmitted by transmitter 32. The second signal is a signal that training device 14 is responsive to. The transmission can be in the form of a wireless transmission and examples of the translation of signals are shown in the following table (which is not meant to be an inclusive list, other applications are contemplated and not contained therein):

| Current Collar | Clip On | Function |
|---|---|---|
| Containment | Remote Sensor (RF) | Allows containment to be |
| | | activated via remote control |
| Containment | Bark Sensor | Allows containment to be |
| | | activated via a dogs bark |
| Containment | “Zones” | Allows a normal containment |
| | | receiver to be activated by a |
| | | “Zones” Indoor avoidance |
| | | transmitter |
| Remote Receiver | Containment | Allows remote collar to be |
| (RF trainer) | | activated by exposure to |
| | | containment field |
| Remote Receiver | “Zones” | Allows remote collar to be |
| (RF trainer) | | activated by exposure to |
| | | “Zones” Indoor avoidance |
| | | transmitter |
| Remote Receiver | Bark Sensor | Allows remote to be activated |
| (RF trainer) | | via a dogs bark |
| “Zones” Receiver | Containment | Allows a Zones receiver to be |
| | | activated by a standard |
| | | containment signal |
| “Zones” Receiver | Remote Sensor | Allows a Zones receiver to be |
| | | activated via remote control |
| “Zones” Receiver | Bark Sensor | Allows a Zones receiver to be |
| | | activated via a dogs bark |

References to ‘containment’ are referring to animal containment systems of an Invisible Fence™ type configuration. References to ‘remote receivers’ are referring to system responsive to transmitters, usually hand-held, that are activated by trainers for training dogs. References to ‘zones’ are referring to systems which warn dogs away from certain zones, which can be established by transmitters located in the zone.

Training device 14 is containment type collar, which responds to an Invisible Fence™ type configuration. Training device 14 responds to a radio frequency (RF) signal when the animal approaches the border defined by a buried transmitting wire. If translator assembly 16 includes a RF receiver then translator assembly 16 can receive a signal activated by a trainer by way of a remote control and translate the activated signal by translating it into a signal that causes the containment device to activate the stimulus, thereby converting a containment collar into one that responds to remote control.

In a like manner translator assembly 16 may include a bark sensor 30, which is an embodiment of a receiver 30 that detects audio signals. Bark sensor 30 detects the barking of the animal and causes transmitter 32 to emit a signal causing training device 14, in this example a containment collar, to provide a stimulus to the animal.

In a similar fashion a remote receiver embodiment of training device 14, also known as an RF trainer can be modified to become a containment collar.

Advantageously the present invention allows the pet owner to customize the training device to take on new rolls in a cost effective manner. This allows a trainer to modify animal training system 10 to be as responsive as necessary for the training of an animal.

Although just one translator assembly 16 has been discussed, more than one can be added to a collar 12 to provide greater functionality of training system 10. Additionally although only one function has been discussed relative to a translator assembly 16, it is also contemplated that a single translator assembly 16 may perform multiple functions, such as, receiving multiple signals, translating those signals and transmitting an appropriate signal to training device 14.

The table above gives some examples of the dual purposes that are possible utilizing a translator assembly 16. Translator assembly 16 can be easily removed, if desired, to return training device 14 to its original configuration so as to function as originally purposed.

Although not shown, translator assembly 16 contains a power source that is replaceable and can be inserted therein to power receiver 30, transmitter 32 and translator 34. Additionally, translator 34 has been described as a device, but can be implemented as an algorithm and integrated into either receiver 30 or transmitter 32. Also receiver 30 and transmitter 32 have been largely described as RF type receiver transmitters yet other mediums of communication are also contemplated such as optical, audio and mechanical.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An animal training system, comprising:
a translator including:
at least one receiver that receives a first signal; and
at least one transmitter communicatively coupled to said at least one receiver, said at least one transmitter transmitting a second signal dependent on said first signal.

2. The system of claim 1, further comprising:
a collar; and
a receiver unit attached to said collar, said translator including a housing containing said at least one receiver of said translator and said at least one transmitter, said housing being removably coupled to the collar.

3. The system of claim 2, wherein said housing is separable into a first portion and a second portion, said first portion having at least one prong attached thereto including a first prong, said second portion having at least one prong attached thereto including a second prong, said first portion and said second portion being assembled with a portion of the collar between said housing on one side of the collar and said first prong and said second prong on an other side of the collar.

4. The system of claim 3, wherein said first prong and said second prong are substantially parallel to each other.

5. The system of claim 3, further comprising a locking mechanism that removably couples said first portion and said second portion.

6. The system of claim 1, wherein said first signal is translated into said second signal thereby conveying information from said first signal to said second signal.

7. The system of claim 6, further comprising:
a collar; and
a behavior modification device including a receiver unit attached to said collar, said second signal conveying a command to said receiver unit, said first signal being generated by a sensor that is not contained in said behavior modification device.

8. The system of claim 1, wherein said at least one receiver responds to an audio signal.

9. An animal behavior modification system, comprising:
an animal collar including a stimulus portion for contact with an animal and a receiving portion to receive a signal to activate said stimulus portion; and
a translator including:
at least one receiver that receives a first signal; and
at least one transmitter coupled to said at least one receiver, said at least one transmitter transmitting a second signal to said receiver portion, said second signal being based on said first signal.

10. The system of claim 9, wherein said translator further includes a housing containing said at least one receiver and said at least one transmitter, said housing being removably coupled to said animal collar.

11. The system of claim 10, wherein said housing is separable into a first portion and a second portion, said first portion having at least one prong attached thereto including a first prong, said second portion having at least one prong attached thereto including a second prong, said first portion and said second portion being assembled with a portion of said collar between said housing on one side of said collar and said first prong and said second prong on an other side of said collar.

12. The system of claim 11, wherein said first prong and said second prong are substantially parallel to each other.

13. The system of claim 11, wherein said translator further includes a locking mechanism that removably couples said first portion and said second portion.

14. The system of claim 9, wherein said first signal is translated into said second signal thereby conveying information from said first signal to said second signal.

15. The system of claim 9, wherein said at least one receiver of said translator receives an audio signal.

16. A method of translating an input signal, comprising the steps of:
receiving the input signal by way of a receiver, the input signal being one that would not be acted upon by an animal behavior modification unit; and
sending an output signal by way of a transmitter, said output signal being received by and acted upon by said animal behavior modification unit.

17. The method of claim 16, wherein said animal behavior modification unit is responsive to said output signal being one of a containment signal, a training signal and a zones signal, the input signal being one of a containment signal, a training signal, a zones signal and a bark signal, the input signal being translated to said output signal.

18. The method of claim 16, wherein said receiver is a bark sensor.

19. The method of claim 16, wherein said receiver and said transmitter are contained in a housing that is removably coupled to an animal collar that has said animal behavior modification unit attached thereto.

20. The method of claim 19, wherein said housing is removable from said animal collar without removing said animal collar from an animal.
